(19) United States
(12) Patent Application Publication
(10) Pub. No.: US 2022/0276371 A1
(43) Pub. Date: Sep. 1, 2022

(54) DELAY DEVICE AND METHOD OF EMULATING RADAR SIGNAL PROPAGATION DELAYS

(71) Applicant: Nanowave Technologies Inc., Etobicoke (CA)

(72) Inventors: Charles William Tremlett NICHOLLS, Nepean (CA); Daniel Peter GALE, Oxford Mills (CA)

(21) Appl. No.: 17/634,592

(22) PCT Filed: Aug. 13, 2020
(86) PCT No.: PCT/CA2020/051109

§ 371 Date: Feb. 11, 2022

Related U.S. Application Data
(60) Provisional application No. 62/885,897, filed on Aug. 13, 2019.

(51) Int. Cl. G01S 13/58; G01S 7/40; G01S 7/41

(52) U.S. Cl. CPC G01S 13/582; G01S 7/4065; G01S 7/414

(57) ABSTRACT

A delay device includes a tuning network including first and second tuning components having frequency responses that overlap in an intermediate frequency band to provide a group delay response. A delay modifier is in communication with the tuning network and configured to provide an offset frequency as an input to the tuning network, and to electronically adjust a group delay value associated with the group delay response by varying the offset frequency. The difference between a frequency of an input reference signal and a local oscillator frequency produced by the delay modifier is substantially equal to an intermediate frequency of the tuning network. The tuning network and the delay modifier cooperate to transpose the reference signal at the reference frequency down to the IF band before passing through the first and second delay lines, and back up to the RF band after passing through the first and second delay lines.

### CROSS REFERENCE TO RELATED APPLICATIONS

The present disclosure is related to co-pending patent application entitled “TRANSPOSED DELAY LINE OSCILLATOR” filed of even date herewith, which is incorporated herein by reference.

### FIELD

The present disclosure relates to systems using radio frequency (RF) signals, such as RADAR (Radio Detection and Ranging) systems, including but not limited to testing RADAR antenna systems and RADAR sensitivity.

### BACKGROUND

Pulse Doppler RADAR fundamental operation consists of transmitting a short duration electromagnetic pulse and determining the characteristics of location and speed of the target based on the returned echo signal.

In order to conduct test of a RADAR system, it is desirable to be able to emulate the signal delays associated with pulse time of flight.

Known RADAR test sets employ long fiber optical delay lines to achieve a series of discrete selectable time delays. The optical delay line test systems are physically large as a result of the physically long fiber spools required. The optical systems currently available also are limited to discrete time delays.

Improvements in RADAR architecture and related delay lines are desirable.

### BRIEF DESCRIPTION OF THE DRAWINGS

Embodiments of the present disclosure will now be described, by way of example only, with reference to the attached Figures.

FIG. 1 illustrates a delay device, for example an electronically tunable delay line, according to an embodiment of the present disclosure.

FIGS. 2A and 2B are graphs illustrating a delay versus frequency plot of the delay lines in FIG. 1.

FIG. 3 is a graph illustrating a group delay response for the delay device of FIG. 1.

FIG. 4 illustrates a delay device, for example an electronically tunable delay line, according to another embodiment of the present disclosure.

FIG. 5 illustrates application of a delay device, for example an electronically tunable delay line, for emulation of multiple RADAR target returns, according to an embodiment of the present disclosure.

FIG. 6 illustrates a block diagram of system including a delay device, for example an electronically tunable delay line, configured for emulation of multiple RADAR target returns, according to an embodiment of the present disclosure.

FIGS. 7 and 8 are detailed graphs illustrating exemplary group delay responses at various frequency offsets for the electronically tunable delay line of FIG. 1 using specific dispersive delay lines.

FIG. 9 is a detailed graph illustrating exemplary group delay responses for the electronically tunable delay line of FIG. 1 using specific dispersive delay lines and resulting from a variation in frequency offset between the two delay lines in steps of 0.5 MHz from −3 MHz to +3 MHz.

FIG. 10 illustrates a delay device, for example an electronically tunable delay line, according to another embodiment of the present disclosure including identical delay lines.

FIG. 11 is a graph illustrating delay versus frequency for an example embodiment of the delay device of FIG. 19 using dispersive delay lines.

FIG. 12 is a graph illustrating in further detail the upper and lower sideband of the transposed dispersive delay of FIG. 11.

FIG. 13 is a graph illustrating delay versus frequency for another example embodiment of the delay device of FIG. 10 using dispersive delay lines and showing LO offset adjustment.

FIGS. 14, 15, 16 and 17 are graphs illustrating delay versus frequency for a combined group delay response at different LO offset adjustments according to example embodiments of the present disclosure.

FIG. 18 illustrates a delay device, for example an electronically tunable delay line, according to another embodiment of the present disclosure including identical delay lines and image rejection mixer mirroring.

FIGS. 19A, 19B and 19C illustrate graphs of individual and composite delay of the delay device of FIG. 18.

FIG. 20 illustrates a block diagram of a known pulse Doppler RADAR showing target echo masking resulting from ground clutter.

FIG. 21A illustrates a plot of phase noise versus frequency for the system of FIG. 20, showing the target echo masked by phase noise-induced clutter.

FIG. 21B illustrates a plot of phase versus time for the system of FIG. 20.

FIG. 22 illustrates a block diagram of a pulse Doppler RADAR including an electronically tunable delay line according to an embodiment of the present disclosure.

FIG. 23 illustrates a plot of phase noise versus frequency for the system of FIG. 22, showing the target echo visible above ground clutter.

FIG. 24 illustrates an electronically tunable delay line according to another embodiment of the present disclosure including identical delay lines and image rejection mixer mirroring and a phase noise suppression loop.

### DETAILED DESCRIPTION

A delay device includes a tuning network including first and second tuning components having frequency responses that overlap in an intermediate frequency (IF) band to provide a group delay response for the tuning network. A delay modifier is in communication with the tuning network and configured to provide an offset frequency as an input to the tuning network, and to electronically adjust a group delay value associated with the group delay response by varying the offset frequency. The delay modifier is also configured to provide a local oscillator frequency. The difference between a frequency of an input reference signal and the local oscillator frequency is substantially equal to an intermediate frequency of the tuning network. The tuning network and the delay modifier cooperate to transpose the reference signal at the reference frequency down to the IF band before passing through the first and second delay lines, and back up to the RF band after passing through the first and second delay lines.

An electronically tunable delay line according to an embodiment of the present disclosure addresses the need to be able to delay RADAR signals for the purpose of RADAR system test. An electronically tunable delay line according to another embodiment of the present disclosure addresses the need to be able to delay RADAR signals as a means to improve the RADAR sensitivity.

Embodiments of the present disclosure enable a compact delay line construction with electronically tunable broad band delay providing unique advantage with respect to laboratory testing of RADAR systems. In an embodiment, the delay characteristic is substantially flat over a bandwidth equal to or greater than the operating bandwidth of the RADAR. As such, the RADAR signal is delayed equally at all frequencies within its bandwidth.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

In an aspect, disclosed herein is a delay device comprising a tuning network configured to receive a reference signal at a reference frequency (f_{REF}) and configured to produce a radio frequency (RF) output signal in an RF band, the tuning network including a first tuning component including a first delay line, the first tuning component having a first frequency response, and a second tuning component in communication with an output of the first tuning component such that the output of the first tuning component is provided as an input to the second tuning component, the second tuning component including a second delay line, the second tuning component having a second frequency response; the first and second frequency responses of the first and second tuning components overlapping in an intermediate frequency (IF) band to provide a group delay response for the tuning network, and a delay modifier in communication with the tuning network and configured to provide an offset frequency as an input to the tuning network and to electronically adjust a group delay value associated with the group delay response by varying the offset frequency, the delay modifier configured to provide a local oscillator frequency, the difference between the reference frequency (f_{REF}) and the local oscillator frequency being substantially equal to an intermediate frequency of the tuning network, and the tuning network and the delay modifier cooperating to transpose the reference signal at the reference frequency down to the IF band before passing through the first and second delay lines, and back up to the RF band after passing through the first and second delay lines.

In an example embodiment, the delay modifier is configured to electronically adjust the center frequency of the group delay response to adjust the group delay value.

In an example embodiment, the reference signal and the RF output signal are both in a RADAR frequency band and the delay device is for use in a RADAR system.

In an example embodiment, the reference signal and the RF output signal are both in a frequency range of about 8.0 GHz to about 12.0 GHz.

In an example embodiment, the tuning network and the delay modifier cooperate to transpose the reference signal at the reference frequency down to the intermediate frequency band before passing through the first and second delay lines, and back up to the RADAR frequency band after passing through the first and second delay lines.

In an example embodiment, a delay characteristic of the group delay response is substantially flat over a bandwidth equal to or greater than an operating bandwidth of the RADAR system such that a RADAR signal is delayed equally at all frequencies within its bandwidth.

In an example embodiment, the tuning network and the delay modifier cooperate to transpose the reference signal at the reference frequency down to the intermediate frequency band before passing through the first and second delay lines, and back up to an RF frequency band after passing through the first and second delay lines.

In an example embodiment, the delay modifier comprises first and second frequency sources providing first and second local oscillator (LO) frequencies, respectively, and the offset frequency is based on a difference between the first and second local oscillator frequencies.

In an example embodiment, the delay modifier is configured to electronically adjust the group delay value by adjusting the first local oscillator frequency or the second local oscillator frequency.

In an example embodiment, the first tuning component further comprises: a first frequency mixer configured to receive the reference signal and the first tuning frequency as inputs and configured to provide a first mixer output as an input to the first delay line;

and a second frequency mixer configured to receive the output of the first delay line and the first tuning frequency as inputs and configured to provide a second mixer output as the output of the first tuning component; and the second tuning component further comprises: a third frequency mixer configured to receive the output of the first tuning component and the second tuning frequency as inputs and configured to provide a third mixer output as an input to the second delay line; and a fourth frequency mixer configured to receive the output of the second delay line and the second tuning frequency as inputs and configured to provide the RF output signal as the output of the fourth frequency mixer.

In an example embodiment, the first frequency mixer, the second frequency mixer, the third frequency mixer and the fourth frequency mixer each comprise an image rejection mixer configured to remove a sideband signal from the output RF signal.

In an example embodiment, the first frequency mixer, the second frequency mixer, the third frequency mixer and the fourth frequency mixer each comprise a double balance mixer configured to remove a sideband from the output RF signal, and the delay device further comprising: a filter at the output of each of the first frequency mixer, the second frequency mixer, the third frequency mixer and the fourth frequency mixer to remove a sideband signal from the output RF signal.

In an example embodiment, the delay modifier comprises: a first microwave synthesizer in communication with the first delay line and providing a first frequency as an input to the first delay line; a second microwave synthesizer in communication with the second delay line and providing a second frequency as an input to the second delay line; the delay modifier being configured to electronically adjust the group delay value by adjusting a difference between the first frequency and the second frequency such that the RF signal is converted to a passband of the IF processing component.

In an example embodiment, the first microwave synthesizer provides the first frequency in an IF band and the second microwave synthesizer provides the second frequency in the IF band.

In an example embodiment, the first and second frequencies provided by the first and second microwave synthesizers are between about 10 MHz and about 3 GHz.

In an example embodiment, the first and second frequencies provided by the first and second microwave synthesizers are between about 10 kHz and about 3 GHz.

In an example embodiment, the first and second microwave synthesizers are implemented using direct digital synthesis technology or fractional-N synthesis technology such that the frequency offset is adjustable at a sub-hertz level, which enables fine electronic control of the group delay.

In an example embodiment, the first microwave synthesizer provides a first local oscillator frequency, and the second microwave synthesizer provides a second local oscillator frequency.

In an example embodiment, the first and second delay lines each comprise frequency dispersive filters having a delay which is a function of the IF signal frequency equal to the difference between the input frequency value and the LO frequency value.

In an example embodiment, the first and second delay lines each comprise dispersive surface acoustic wave (SAW) filters.

In an example embodiment, the first delay line and the second delay line comprise substantially identical dispersive surface acoustic wave (SAW) filters.

In an example embodiment, the first delay line and the second delay line comprise substantially identical dispersive surface acoustic wave (SAW) filters having a dispersion slope, and the tuning network further comprises a plurality of image rejection mixers in communication with the delay modifier and in communication with the first and second delay lines, the plurality of image rejection mixers configured to mirror the second delay line about the first tuning frequency to invert the dispersion slope of the second delay line.

In an example embodiment, the plurality of image rejection mixers comprises first, second, third and fourth image rejection mixers, the first tuning component comprising the first delay line coupled between the first and second image rejection mixers; the second tuning component comprising the second delay line coupled between the third and fourth image rejection mixers.

In an example embodiment, the delay device further comprises a first power splitter provided after the first frequency source and before the first LO signal is provided to the first and second image rejection mixers; and a second power splitter provided after the second frequency source and before the second LO signal is provided to the third and fourth image rejection mixers.

In an example embodiment, the delay device further comprises a plurality of hybrid couplers and a plurality of sideband selection switches, the plurality of hybrid couplers cooperating with the plurality of sideband selection switches to enable selection of a lower or upper sideband to enable mirroring of the dispersion gradient and to generate quadrature signals at the image rejection mixer IF port.

In an example embodiment, the delay device further comprises a plurality of hybrid couplers and a plurality of sideband selection switches, the first tuning component comprising one of the hybrid couplers and one of the sideband selection switches at each end of the first delay line; the second tuning component comprising one of the hybrid couplers and one of the sideband selection switches at each end of the second delay line.

In an example embodiment, the first tuning component comprises a first hybrid coupler and a first sideband selection switch provided between the first image rejection mixer and the first delay line, and a second hybrid coupler and a second sideband selection switch provided between the first delay line and the second image rejection mixer; the second tuning component comprises a third hybrid coupler and a third sideband selection switch provided between the third image rejection mixer and the second delay line, and a fourth hybrid coupler and a fourth sideband selection switch provided between the second delay line and the fourth image rejection mixer.

In an example embodiment, the delay device further comprises: a microwave spurious suppression filter configured to receive the output of the second tuning component and to output a delayed RF output, the microwave spurious suppression filter being selected to suppress the first and second LO signals and lower sideband components.

In an example embodiment, the first frequency response of the first tuning component has a positive delay-versus-frequency slope; and the second frequency response of the second tuning component has a negative delay-versus-frequency slope.

In an example embodiment, the first delay line and the second delay line are substantially identical dispersive surface acoustic wave (SAW) filters each having a center frequency of f_{CF}, and the delay modifier produces the first and second LO frequencies based on f_{REF}−f_{CF} and f_{REF}+f_{CF}.

In an example embodiment, the first tuning frequency is substantially equal to f_{REF}−f_{CF} and the second tuning frequency is substantially equal to f_{REF}+f_{CF}.

In an example embodiment, the first and second frequency responses of the first and second delay lines overlap in the intermediate frequency band to provide a substantially flat group delay response in a passband of a composite filter for the tuning network.

In an example embodiment, when the offset frequency is adjusted by 1 MHz, the group delay response increases by about 4.5 microseconds while maintaining a substantially flat group delay response.

In an example embodiment, the group delay response is a function of the offset frequency and is independent of the reference frequency of the reference signal.

In an example embodiment, the group delay response is based on D1+D2=((dt/df))*Δf+t0+t1, where D1=(−dt/df)*f+t0, and is a first delay based on the dispersion gradient of the first SAW filter D2=(dt/df)*(f+Δf)+t1, and is a second delay based on the inverted dispersion gradient of the second SAW filter and where D1+D2 is a function of the offset frequency and is independent of the reference frequency of the reference signal.

In an example embodiment, the RADAR frequency band comprises an X-band frequency range.

In an example embodiment, the delay line has an operational bandwidth equivalent to the operational bandwidth of the first and second tuning components.

In an example embodiment, the operational bandwidth of the first and second tuning components is from about 100 MHz to about 40 GHz.

In an example embodiment, the intermediate frequency band is defined by a range of about 10 MHz to about 3 GHz.

In an example embodiment, the tuning network and the delay modifier cooperate to transpose the reference signal at the reference frequency down to the intermediate frequency band before passing through the first and second delay lines, such that a ratio of the reference signal at the reference frequency to the transposed reference signal in the intermediate frequency band is about 1000:1.

In an example embodiment, the ratio of the reference signal at the reference frequency to the transposed reference signal in the intermediate frequency band is about 100:1.

In another aspect, disclosed herein is a delay device comprising: a tuning network configured to receive a reference signal at a reference frequency (f_{REF}) and configured to produce a radio frequency (RF) output signal in an RF band, the tuning network including: a first tuning component including a first delay line, the first tuning component having a first frequency response, and a second tuning component including a second delay line, the second tuning component having a second frequency response; the first and second frequency responses of the first and second tuning components overlapping in an intermediate frequency (IF) band to provide a group delay response for the tuning network; and a delay modifier in communication with the tuning network and configured to provide an offset frequency as an input to the tuning network and to electronically adjust a group delay value associated with the group delay response by varying the offset frequency, the delay modifier configured to provide a local oscillator frequency, the difference between the reference frequency (f_{REF}) and the local oscillator frequency being substantially equal to an intermediate frequency of the tuning network, and the tuning network and the delay modifier cooperating to transpose the reference signal at the reference frequency down to the IF band before passing through the first and second delay lines, and back up to the RF band after passing through the first and second delay lines.

In an example embodiment, the second tuning component is configured in parallel with the first tuning component so as to emulate multiple RADAR target returns occurring at different distances from the RADAR system.

In an example embodiment, the first and second tuning components are provided in a plurality of parallel tuning components, each tuning component comprising an electronically tunable delay line, configured to provide a plurality of parallel delay paths configured to emulate a plurality of target returns.

In another aspect, disclosed herein is a method of emulating radar signal propagation delays between a RADAR and a target in a RADAR system under test, comprising: receiving, at a tuning network including first and second tuning components having first and second delay lines, respectively, a reference signal at a reference frequency (f_{REF}) in a RADAR frequency band; transposing, at the tuning network, the reference signal at the reference frequency down to an intermediate frequency band before passing through the first and second delay lines, and back up to the RADAR frequency band after passing through the first and second delay lines, an output of the first tuning component being provided as an input to the second tuning component, the first and second tuning components having first and second frequency responses, respectively, which overlap in the intermediate frequency band to provide a group delay response for the tuning network; providing an offset frequency as an additional input to the tuning network; electronically adjusting a group delay value associated with the group delay response by varying the offset frequency; and producing a radio frequency (RF) output signal, the RF output signal being in the RADAR frequency band.

In an example embodiment, receiving the reference signal at the reference frequency in an X-band frequency range; transposing the reference signal at the reference frequency down to the intermediate frequency band and back up to the X-band frequency range; and producing the RF output signal in the X-band frequency range.

In another aspect, disclosed herein is a method of improving sensitivity of a communication signal transmission system configured to detect a target, comprising: obtaining a local oscillator signal; delaying the local oscillator signal by a time duration equal to a pulse round trip flight of interest between the system and the target within a distance range; and providing the delayed local oscillator signal to a receiver down converter mixer so as to cancel oscillator phase noise for a range of interest, resulting in an improvement in the clutter to signal ratio of the system.

In an example embodiment, the communication signal transmission system comprises a Radio Detection And Ranging (RADAR) system.

To the extent a term used herein is not defined below, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

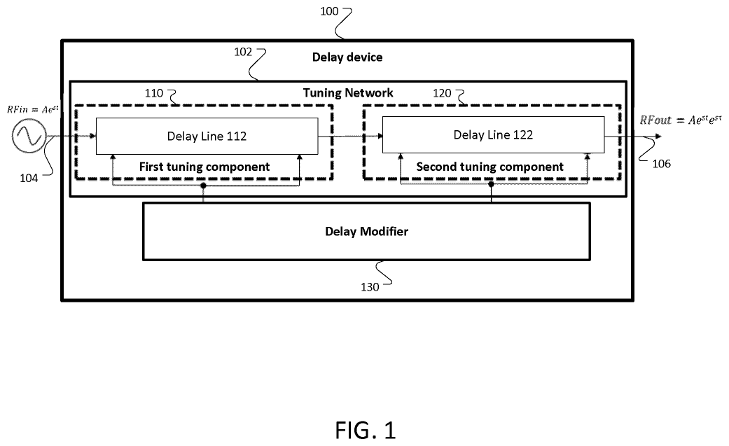

FIG. 1 illustrates a delay device 100, for example an electronically tunable delay line, according to an embodiment of the present disclosure. The delay device 100 comprises a tuning network 102 configured to receive a reference signal (RFᵢₙ) 104 at a reference frequency (f_{REF}) and configured to produce a radio frequency (RF) output signal (RFₒᵤₜ) 106 in an RF band. In an embodiment, the reference frequency f_{REF} is in the RF band. The tuning network 102 includes a first tuning component 110 and a second tuning component 120. The first tuning component 110 includes a first delay line 112, and the first tuning component has a first frequency response. The second tuning component 120 is in communication with an output of the first tuning component 110 such that the output of the first tuning component is provided as an input to the second tuning component. The second tuning component 120 includes a second delay line 122, and the second tuning component has a second frequency response. The first and second frequency responses of the first and second tuning components overlap in an intermediate frequency band to provide a group delay response for the tuning network 102.

The delay device further includes a delay modifier 130 in communication with the tuning network 102 and configured to provide an offset frequency as an input to the tuning network. The delay modifier 130 is configured to electronically adjust a group delay value associated with the group delay response by varying the offset frequency. In an example embodiment, the delay modifier is configured to electronically adjust the center frequency of the group delay response to adjust the group delay value.

The delay modifier 130 is configured to provide a local oscillator (LO) frequency. In an embodiment, the LO frequency is obtained from one or more frequency sources or microwave synthesizers, which can be external to the delay device. In an example embodiment, such frequency sources external to the delay device are each under independent control, for example via a control port enabling computer control via a graphical user interface. The difference between the reference frequency f_{REF} of the reference signal RFᵢₙ and the LO frequency is substantially equal to an intermediate frequency (IF) of the tuning network. In an embodiment, the first and second delay lines 112 and 122 both operate at an internal IF frequency set by the delay modifier frequency and the input frequency to the network. In an example embodiment, the reference frequency f_{REF} is subtracted from the LO frequency to provide a result that is substantially equal to the IF of the tuning network. In another example embodiment, the LO frequency is subtracted from the reference frequency f_{REF} to provide a result that is substantially equal to the IF of the tuning network. The tuning network 102 and the delay modifier 130 cooperate to transpose the reference signal at the reference frequency f_{REF} down to the IF band before passing through the first and second delay lines, and back up to the RF band after passing through the first and second delay lines.

In an example embodiment, the reference signal and the RF output signal are both in a RADAR frequency band and the delay device is for use in a RADAR system. In example embodiments, the tuning network and the delay modifier cooperate to transpose the reference signal at the reference frequency down to the IF band before passing through the first and second delay lines, and back up to a RADAR frequency band, or an RF frequency band, after passing through the first and second delay lines. In an example implementation, the reference signal and the RF output signal are both in a frequency range of about 8.0 GHz to about 12.0 GHz. In an example embodiment, the RADAR frequency band comprises an X-band frequency range. In an embodiment, the delay characteristic of the group delay response is substantially flat over a bandwidth equal to or greater than the operating bandwidth of the system, including RADAR systems, or other systems implementing electronically controlled broadband delay lines. In an embodiment, the RADAR signal is delayed equally at all frequencies within its operating bandwidth.

In an example embodiment, the group delay response is a function of the offset frequency and is independent of the reference frequency of the reference signal. In an example embodiment, when the offset frequency is adjusted by 1 MHz, the group delay response increases by about 4.5 microseconds while maintaining a substantially flat group delay response.

In an example embodiment, the tuning network 102 and the delay modifier 130 cooperate to transpose the reference signal at the reference frequency down to the IF band before passing through the first and second delay lines, such that a ratio of the reference signal at the reference frequency to the transposed reference signal in the intermediate frequency band is about 100:1. As an example, in such an embodiment having a 100:1 transposition ratio, about 100 MHz IF transposes to about 10 GHz, and vice-versa. In another example embodiment, the ratio of the reference signal at the reference frequency to the transposed reference signal in the intermediate frequency band is about 1000:1.

In an example embodiment, the delay device 100 has an operational bandwidth equivalent to the operational bandwidth of the first and second tuning components 110 and 120. In an example implementation, the operational bandwidth of the first and second tuning components is from about 100 MHz to about 40 GHz. In an example implementation, the intermediate frequency band is defined by a range of about 10 MHz to about 3 GHz.

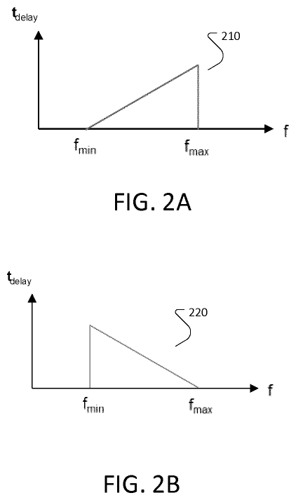

FIGS. 2A and 2B are graphs illustrating a delay versus frequency plot of the delay lines 112 and 122 in FIG. 1. FIG. 2A shows a first frequency response 210 for the first delay line 112, which starts at a low value (for example, zero), increases linearly from fₘᵢₙ to fₘₐₓ, then drops back to the low value at which it started. FIG. 2B shows a second frequency response 220 for the second delay line 122, which starts at a high value, and decreases linearly from fₘᵢₙ to fₘₐₓ, a low value (for example, zero). For to example, the first frequency response of the first tuning component has a positive delay-versus-frequency slope, and the second frequency response of the second tuning component has a negative delay-versus-frequency slope.

Consider an example where the band between fₘᵢₙ and fₘₐₓ is within the IF band, or substantially corresponds to the IF band. FIGS. 2A and 2B, when observed together, provide a visual illustration of the first and second frequency responses of the first and second tuning components overlapping in the IF band to provide a group delay response for the tuning network 102.

In an example embodiment, since the exemplary first and second frequency responses can be described as equal and opposite, the resulting group delay response for the tuning network 102 would be a flat response between fₘᵢₙ and fₘₐₓ. In an example embodiment, the first and second frequency responses of the first and second delay lines 112 and 122 overlap in the IF band to provide a substantially flat group delay response in a passband of a composite filter for the tuning network 102.

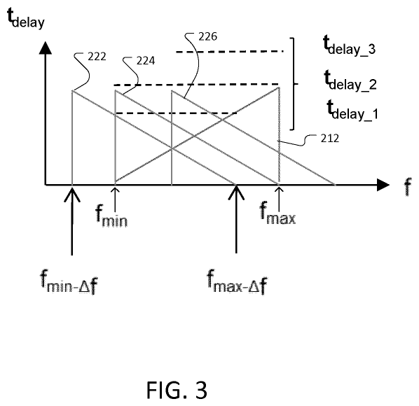

FIG. 3 is a graph illustrating a group delay response for the electronically tunable delay line of FIG. 1. As mentioned above, the frequency responses of the first and second delay lines can be selected to overlap to produce a substantially flat group delay response. By offsetting one of the delay lines, the overlap can be adjusted, enabling the constant passband group delay present in the overlap passband of the two delay lines, or filters, to be adjusted. For a fixed first delay line frequency response 212, the offset can be varied to produce three different second delay line frequency responses 222, 224 and 226, with corresponding delay values.

The second delay line frequency response 222 is offset to have a response between fₘᵢₙ−Δf and fₘₐₓ−Δf, resulting in a delay value of t_{delay_1}. The second delay line frequency response 224 is offset to have a response between fₘᵢₙ and fₘₐₓ, resulting in a delay value of t_{delay_2}, which is higher than the delay value of t_{delay_1} produced by response 222. The third delay line frequency response 226 is offset to have a response between fₘᵢₙ+Δf and fₘₐₓ+Δf , resulting in a delay value of t_{delay_3}, which is higher than the delay value of t_{delay_2} produced by response 224. As mentioned above, the delay modifier 130 is configured to provide an offset frequency to electronically adjust the group delay value associated with the group delay response by varying the offset frequency, which can result in a variation in the group delay response similar to that shown in FIG. 3.

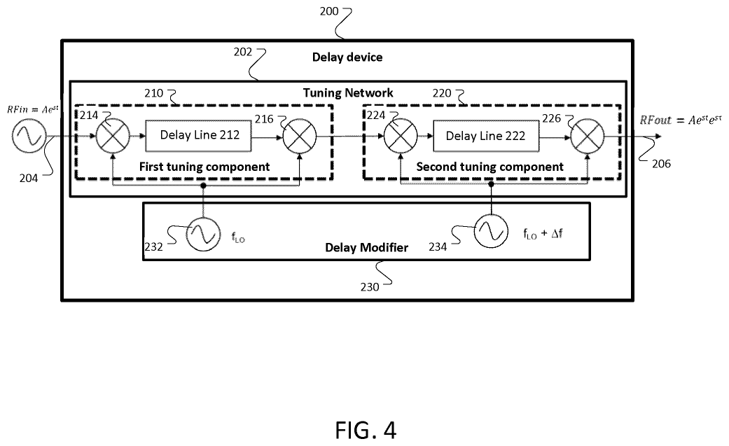

FIG. 4 illustrates a delay device 200, for example an electronically tunable delay line, according to another embodiment of the present disclosure. The delay device 200 as shown in FIG. 4 is similar to the delay device 100 as shown in FIG. 1, with some additional details for this particular embodiment. For example, the delay modifier 230 comprises first and second frequency sources 232 and 234, providing first and second local oscillator (LO) frequencies, respectively. In an embodiment, the offset frequency provided by the delay modifier is based on a difference between the first and second local oscillator frequencies. In the example embodiment of FIG. 4, when the first LO frequency is f_{LO}, the second LO frequency is f_{LO}+Δf, meaning that the difference between the two LO frequencies is Δf, which is also the offset frequency provided by the delay modifier 230. In an example embodiment, the delay modifier 230 is configured to electronically adjust the group delay value by adjusting the first local oscillator frequency or the second local oscillator frequency.

The example embodiment of FIG. 4 further includes a plurality of frequency mixers. For example, the first tuning component 210 further comprises: a first frequency mixer 214 configured to receive the reference signal RFᵢₙ and the first tuning frequency f_{LO} as inputs, and configured to provide a first mixer output as an input to the first delay line 212. The first tuning component 210 also further comprises a second frequency mixer 216 configured to receive the output of the first delay line 212 and the first tuning frequency f_{LO} as inputs, and configured to provide a second mixer output as the output of the first tuning component 210.

Similarly, the second tuning component 220 further comprises: a third frequency mixer 224 configured to receive the output of the first tuning component 210 and the second tuning frequency f_{LO}+Δf as inputs, and configured to provide a third mixer output as an input to the second delay line 222. The second tuning component 220 further comprises a fourth frequency mixer 226 configured to receive the output of the second delay line 222 and the second tuning frequency f_{LO}+Δf as inputs, and configured to provide the RF output signal RFₒᵤₜ 206 as the output of the fourth frequency mixer 226.

In an example embodiment in relation to FIG. 4, the first frequency mixer 214, the second frequency mixer 216, the third frequency mixer 224 and the fourth frequency mixer 226 each comprise an image rejection mixer configured to remove a sideband signal from the output RF signal.

In another example embodiment in relation to FIG. 4, the first frequency mixer 214, the second frequency mixer 216, the third frequency mixer 224 and the fourth frequency mixer 226 each comprise a double balance mixer configured to remove a sideband from the output RF signal. In such an embodiment, the delay device can further comprise a filter (not shown in the figures) at the output of each of the first frequency mixer 214, the second frequency mixer 216, the third frequency mixer 224 and the fourth frequency mixer 226 to remove a sideband signal from the output RF signal.

In an example embodiment in relation to FIG. 4, and also applicable to the embodiment of FIG. 1, the delay modifier comprises: a first microwave synthesizer in communication with the first delay line and providing a first frequency as an input to the first delay line; and a second microwave synthesizer in communication with the second delay line and providing a second frequency as an input to the second delay line. In such embodiments, the delay modifier is configured to electronically adjust the group delay value by adjusting a difference between the first frequency and the second frequency such that the RF signal is converted to a passband of the IF processing component. In an embodiment, the IF processing component comprises the first delay line 212 and the second delay line 222, which operate on the transposed microwave signal. In an example embodiment such as shown in FIG. 4, the first microwave synthesizer provides a first local oscillator frequency, and the second microwave synthesizer provides a second local oscillator frequency.

In an example embodiment, the first microwave synthesizer provides the first frequency in an IF band, and the second microwave synthesizer provides the second frequency in the IF band. In an example embodiment, the first and second IF frequencies provided by the first and second microwave synthesizers are between about 10 MHz and about 3 GHz, or between about 10 kHz at the low end and about 3 GHz. In an example embodiment, the first and second microwave synthesizers are implemented using direct digital synthesis technology or fractional-N synthesis technology such that the frequency offset is adjustable at a sub-hertz level, which enables fine electronic control of the group delay.

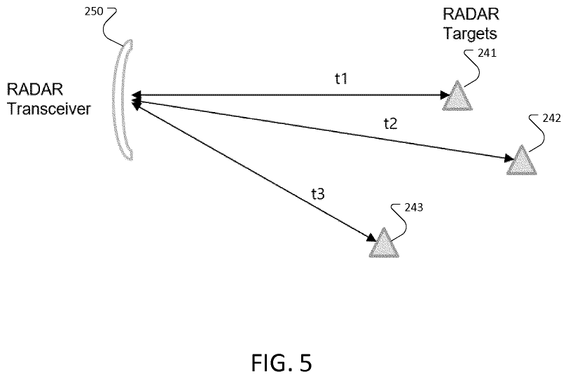

FIG. 5 illustrates the application of a delay device, for example an electronically tunable delay line, for emulation of multiple RADAR target returns according to an embodiment of the present disclosure. The example implementation shown in FIG. 5 includes multiple targets 241, 242, 243 and ground clutter returns t1, t2 and t3 occurring at different distances from the RADAR transceiver 250. A delay device according to an embodiment of the present disclosure can be used to simulate such returns.

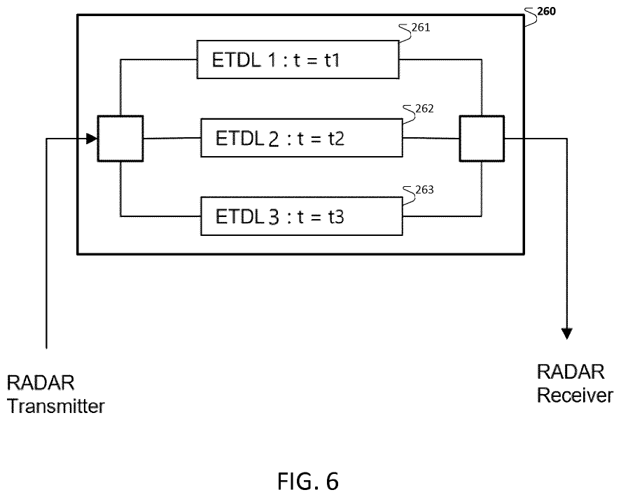

FIG. 6 illustrates a block diagram of a system including a delay device 260, for example an electronically tunable delay line, configured for emulation of multiple RADAR target returns, according to an embodiment of the present disclosure. The system of the example embodiment of FIG. 6 comprises a RADAR transmitter, a plurality of electronically tunable delay lines 261, 262, 263, and a RADAR receiver. The RADAR transmitter and RADAR receiver in FIG. 6 are equivalent to the RADAR transceiver 250 in FIG. 5. In the embodiment of FIG. 6, the delay device 260 comprises first, second and third tuning components provided in parallel, rather than in series as shown in FIG. 4. In such an example embodiment, the delay device 260 includes electronically tunable delay lines 261, 262, 263 configured in parallel to emulate multiple target echo returns t1, t2 and t3.

In an embodiment, the parallel electronically tunable delay lines enable arbitrary delays of the signal as may be required, for example, in the case of simulating multiple targets and ground clutter returns occurring at different distances from the RADAR. In the example embodiment of FIG. 6, the input to the second and third tuning components is the same as the input to the first tuning component. In an example embodiment, the delay device 260 comprises a plurality of parallel tuning components, each tuning component comprising an electronically tunable delay line, configured to provide a plurality of parallel delay paths configured to emulate a plurality of target returns. For example, multiple parallel delay paths can be used in the case of N target returns; a typical system may accommodate 10, or more, parallel delay paths.

Such an example embodiment with first and second tuning components provided in parallel can be provided in the context of a delay device comprising: a tuning network configured to receive a reference signal at a reference frequency (f_{REF}) and configured to produce a radio frequency output signal in an RF band, the tuning network including: a first tuning component including a first delay line, the first tuning component having a first frequency response, and a second tuning component including a second delay line, the second tuning component having a second frequency response; the first and second frequency responses of the first and second tuning components overlapping in an intermediate frequency band to provide a group delay response for the tuning network; and further comprising a delay modifier in communication with the tuning network and configured to provide an offset frequency as an input to the tuning network and to electronically adjust a group delay value associated with the group delay response by varying the offset frequency, the delay modifier configured to provide a local oscillator frequency, the difference between the reference frequency (f_{REF}) and the local oscillator frequency being substantially equal to an intermediate frequency of the tuning network, and the tuning network and the delay modifier cooperating to transpose the reference signal at the reference frequency down to the IF band before passing through the first and second delay lines, and back up to the RF band after passing through the first and second delay lines.

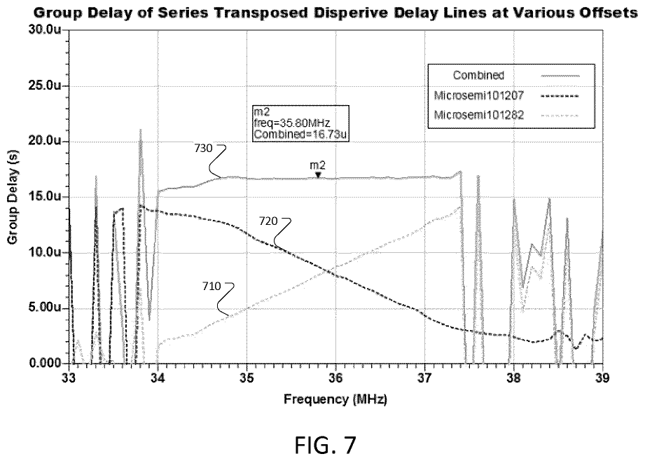

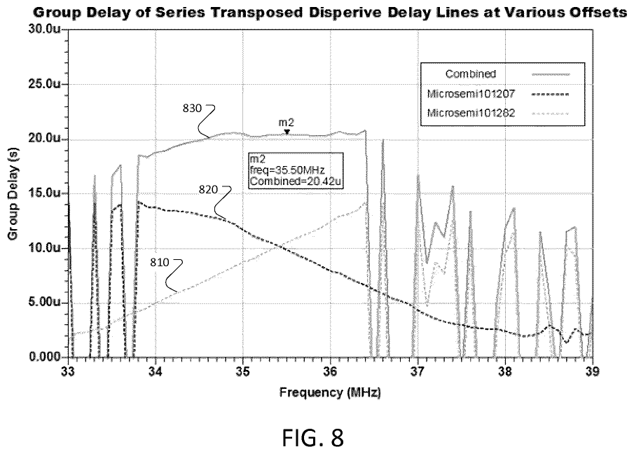

FIGS. 7 and 8 are detailed graphs illustrating exemplary group delay responses at various frequency offsets for the electronically tunable delay line of FIG. 1 using specific dispersive delay lines. In particular, the illustrative examples depicted in FIGS. 7 and 8 relate to group delay responses in an electronically tunable delay line according to an embodiment herein which implement Microsemi dispersive delay lines. In the embodiment of FIG. 7, a first tuning component frequency response 710 is illustrated, along with a second tuning component frequency response 720. The group delay response 730 is shown, which is equivalent to a combination of the responses 710 and 720.

In the example embodiment of FIG. 7, the group delay response 730 is a flat or constant response of a delay of about 17 microseconds between about 34 MHz and about 37.5 MHz. As shown in the embodiment of FIG. 8, when offset by 1 MHz compared to the embodiment of FIG. 7, the group delay 830, or the series combination, increases by about 5 microseconds, to about 22 microseconds, while still showing a relatively flat delay in the passband.

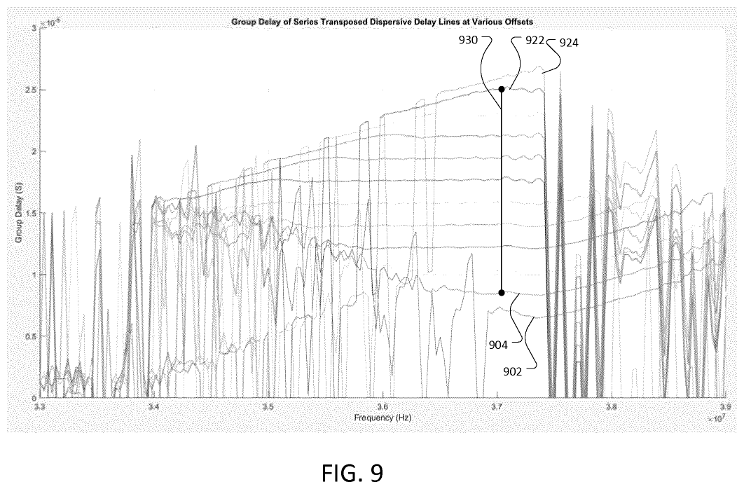

FIG. 9 is a detailed graph illustrating exemplary group delay responses for the electronically tunable delay line of FIG. 1 using specific dispersive delay lines. Twelve exemplary group delay responses are shown in FIG. 9, beginning with 902, then 904 and progressing up the graph to 922 and finally to 924. These twelve exemplary group delay responses result from a variation in frequency offset between the two delay lines in steps of 0.5 MHz from −3 MHz (with respect to 902) to +3 MHz (with respect to 924). A composite time delay variation 930 of 17 microseconds is measured between the group delay responses 904 and 922.

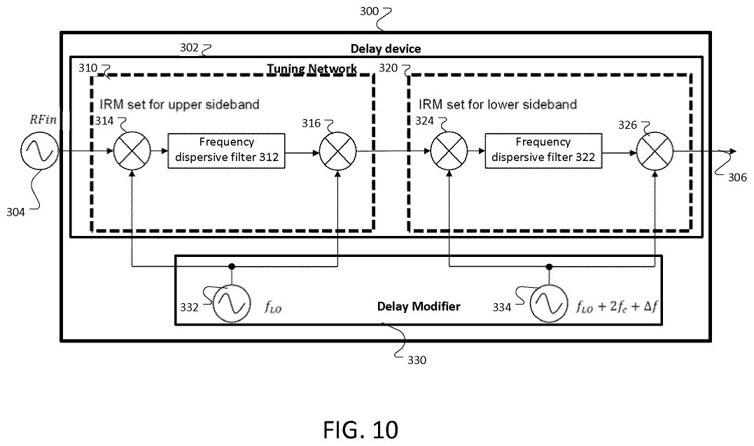

FIG. 10 illustrates a delay device 300, for example an electronically tunable delay line, according to another embodiment of the present disclosure including identical delay lines. The delay device 300 as shown in FIG. 10 is similar to the delay device 200 as shown in FIG. 4, and to the delay device 100 as shown in FIG. 1, with some additional details for this particular embodiment. In the embodiment of FIG. 10, the tuning network 302 comprises a first tuning component 310 comprising a first frequency dispersive filter 312, and a second tuning component 320 comprising a second frequency dispersive filter 322. In the embodiment of FIG. 10, the first and second frequency dispersive filters 312 and 322 each have a delay which is a function of the IF signal frequency equal to the difference between the input frequency value and the LO frequency value. In an example embodiment, the first and second delay lines each comprise dispersive surface acoustic wave (SAW) filters 312 and 322. In a further embodiment, the first delay line and the second delay line comprise substantially identical dispersive SAW filters, for example having substantially the same frequency response.

In an example embodiment, the first frequency response of the first tuning component 310 has a positive delay-versus-frequency slope, and the second frequency response of the second tuning component 320 has a negative delay-versus-frequency slope. When the first delay line 312 and the second delay line 322 are substantially identical dispersive SAW filters each having a center frequency of f_{CF}, in an example embodiment the delay modifier 330 produces the first and second LO frequencies based on f_{REF}−f_{CF} and f_{REF}+f_{CF}. In an example embodiment, the first tuning frequency is substantially equal to f_{REF}−f_{CF} and the second tuning frequency is substantially equal to f_{REF}+f_{CF}.
In a further example embodiment, the group delay response is based on

D1+D2=((dt/df))*Δf+t0+t1,

where
D1=(−dt/df)*f+t0, and is a first delay based on the dispersion gradient of the first SAW filter
D2=(dt/df)*(f+Δf)+t1, and is a second delay based on the inverted dispersion gradient of the second SAW filter
   and where D1+D2 is a function of the offset frequency and is independent of the reference frequency of the reference signal.

In another example embodiment in relation to FIG. 10, the first tuning component 310 and the second tuning component 320 comprise substantially identical dispersive SAW filters having a dispersion slope. The dispersive SAW filters are provided as the first and second delay lines. In such an embodiment, the tuning network further comprises a plurality of image rejection mixers in communication with the delay modifier 330 and in communication with the first and second delay lines 312 and 322, the plurality of image rejection mixers configured to mirror the second delay line 322 about the first tuning frequency to invert the dispersion slope of the second delay line.

In a further example embodiment, the plurality of image rejection mixers comprises first, second, third and fourth image rejection mixers. The first tuning component 310 comprises the first delay line 312 coupled between the first image rejection mixer 314 and the second image rejection mixer 316. In an example embodiment, the first image rejection mixer 314 is set for the upper sideband. The second tuning component 320 comprises the second delay line 322 coupled between the third image rejection mixer 324 and the fourth image rejection mixer 326. In an example embodiment, the third image rejection mixer 324 is set for the lower sideband.

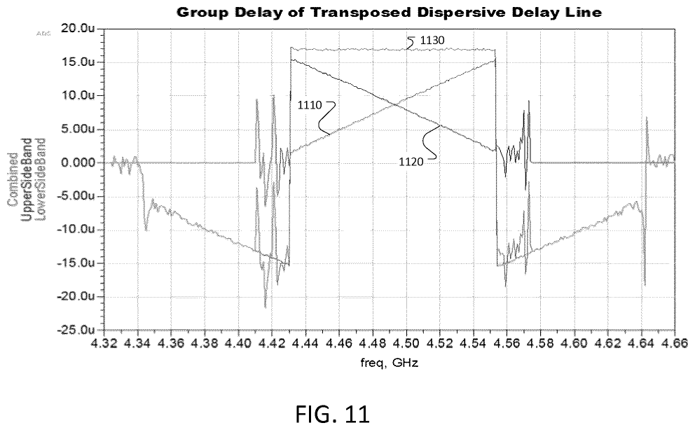

FIG. 11 is a graph illustrating delay versus frequency for an example embodiment of the delay device of FIG. 10 using dispersive delay lines. In FIG. 11, an upper sideband response 1110 and a lower sideband response 1120 are separately illustrated. The combined response, or tuning network response, or group delay, is illustrated as 1130. The upper sideband response 1110 and lower sideband response 1120 are for an example implementation using a dispersive delay line, with the combined response 1130 resulting in a passband with a relatively flat group delay. The example embodiment resulting in the responses shown in FIG. 11 comprises a first dispersive delay line overlapped with a mirrored version of the same dispersive delay line.

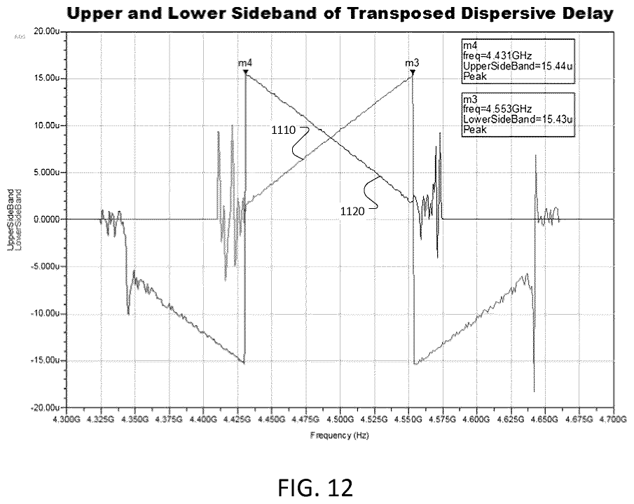

FIG. 12 is a graph illustrating in further detail the upper and lower sideband of the transposed dispersive delay of FIG. 11. The graph of FIG. 12 illustrates an upper sideband peak at a frequency of 4.431 GHz and a delay of 15.44 microseconds, and a lower sideband peak at a frequency of 4.553 GHz and a delay of 15.43 microseconds.

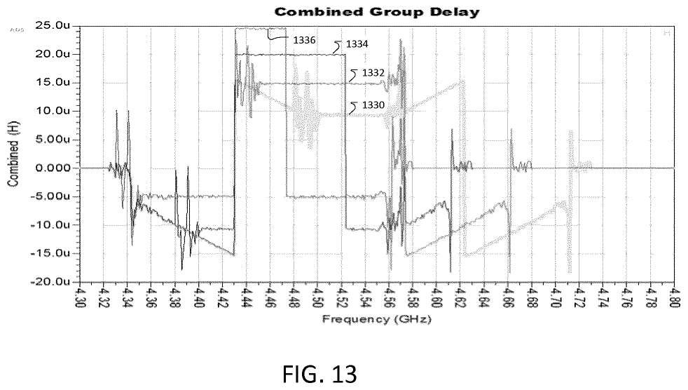

FIG. 13 is a graph illustrating delay versus frequency for another example embodiment of the delay device of FIG. 10 using dispersive delay lines and showing LO offset adjustment. Similar to FIG. 11, the example embodiment resulting in the responses shown in FIG. 13 comprises a first dispersive delay line overlapped with a mirrored version of the same dispersive delay line. FIG. 13 illustrates group responses for the series combination of the upper and lower sideband for the dispersive delay line filters, with the LO offset adjusted. These responses 1330, 1332, 1334 and 1336 show a group delay varying from 10 to 25 microseconds based on the LO offset adjustment.

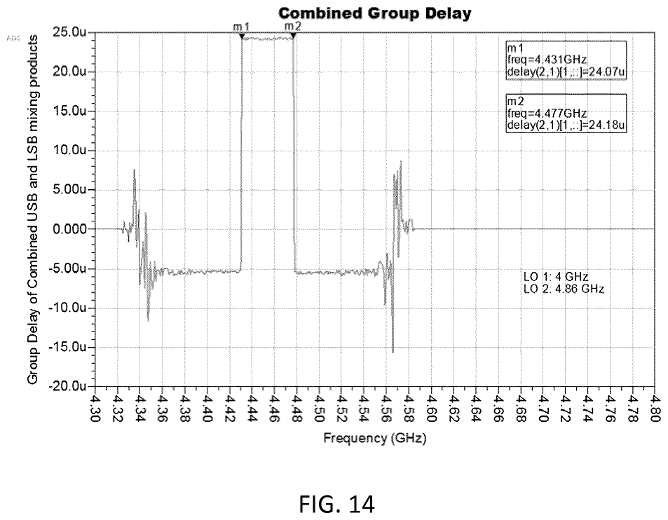

FIGS. 14, 15, 16 and 17 are graphs illustrating delay versus frequency for a combined group delay response, similar to 1336 in FIG. 13, at different LO offset adjustments according to example embodiments of the present disclosure.

FIG. 14 illustrates a combined group delay for an 860 MHz offset, which in the example of FIG. 14 has an LO1 of 4 GHz and an LO2 of 4.86 GHz. The graph of FIG. 14 illustrates a combined group delay with a passband or substantially flat delay characteristic extending from a frequency of 4.431 GHz and a delay of 24.07 microseconds, to a frequency of 4.477 GHz and a delay of 24.18 microseconds.

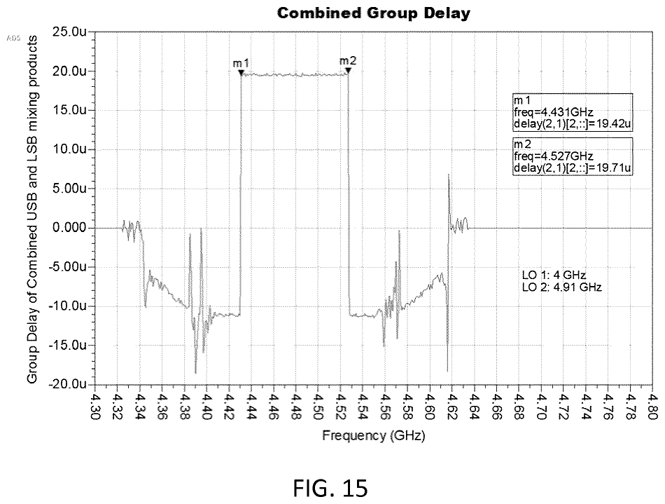

FIG. 15 illustrates a combined group delay for a 910 MHz offset, which in the example of FIG. 15 has an LO1 of 4 GHz and an LO2 of 4.91 GHz. The graph of FIG. 15 illustrates a combined group delay with a passband or substantially flat delay characteristic extending from a frequency of 4.431 GHz and a delay of 19.42 microseconds, to a frequency of 4.527 GHz and a delay of 19.71 microseconds.

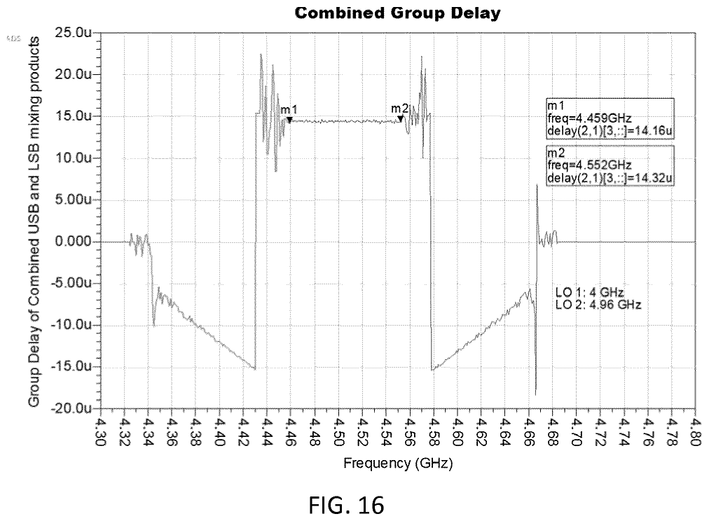

FIG. 16 illustrates a combined group delay for a 960 MHz offset, which in the example of FIG. 16 has an LO1 of 4 GHz and an LO2 of 4.96 GHz. The graph of FIG. 16 illustrates a combined group delay with a passband or substantially flat delay characteristic extending from a frequency of 4.459 GHz and a delay of 14.16 microseconds, to a frequency of 4.552 GHz and a delay of 14.32 microseconds.

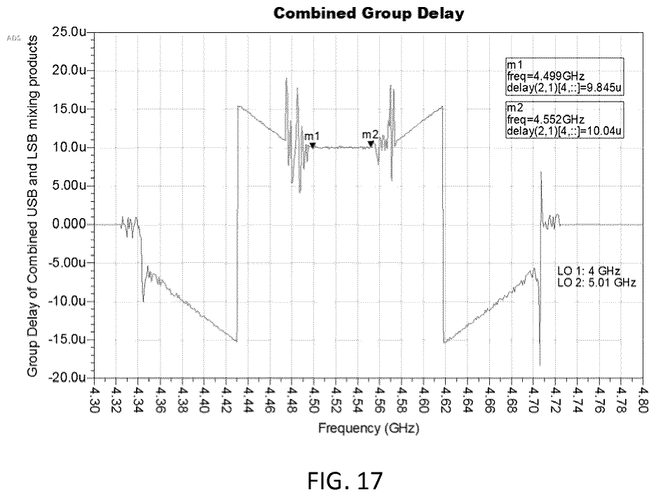

FIG. 17 illustrates a combined group delay for a 1010 MHz offset, which in the example of FIG. 17 has an LO1 of 4 GHz and an LO2 of 5.01 GHz. The graph of FIG. 17 illustrates a combined group delay with a passband or substantially flat delay characteristic extending from a frequency of 4.499 GHz and a delay of 9.845 microseconds, to a frequency of 4.552 GHz and a delay of 10.04 microseconds.

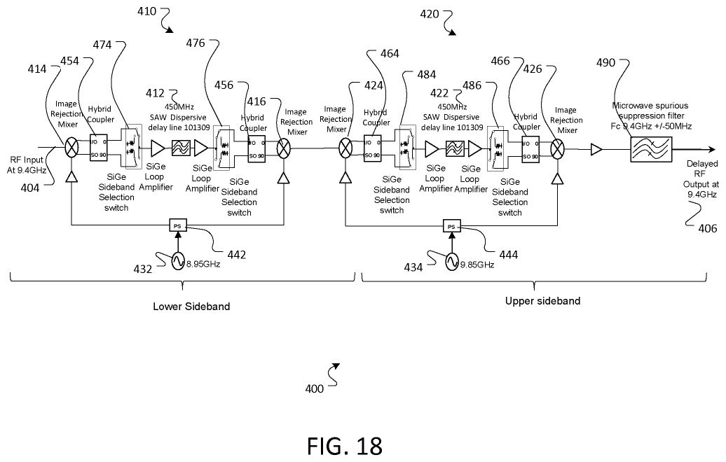

FIG. 18 illustrates a delay device 400, for example an electronically tunable delay line, according to another embodiment of the present disclosure including identical delay lines and image rejection mixer mirroring. The delay device 400 as shown in FIG. 18 is similar to the delay device 300 as shown in FIG. 10, as well as to the delay device 200 as shown in FIG. 4, and to the delay device 100 as shown in FIG. 1, with some additional details for this particular embodiment.

The embodiment of FIG. 18 builds on the embodiment of FIG. 8 having first, second, third and fourth image rejection mixers shown in FIG. 18 as 414, 416, 424 and 426, respectively. The delay device 400 of FIG. 18 further comprises a plurality of hybrid couplers and a plurality of sideband selection switches. In an example embodiment, the plurality of hybrid couplers cooperate with the plurality of sideband selection switches to enable selection of a lower or upper sideband to enable mirroring of the dispersion gradient and to generate quadrature signals at the image rejection mixer IF port. In an example embodiment, the first tuning component 410 comprises one of the hybrid couplers and one of the sideband selection switches at each end of the first delay line 412; the second tuning component 420 comprises one of the hybrid couplers and one of the sideband selection switches at each end of the second delay line 422.

The example embodiment as shown in FIG. 18 has an RF input 404 at 9.4 GHz, a delayed RF output 406, which is also at 9.4 GHz. The first and second frequency sources 432 and 434 are configured to generate first and second local oscillator signals at 8.95 GHz and 9.85 GHz, respectively. The first and second LO signals correspond to RFᵢₙ−450 MHz and to RFᵢₙ+450 MHz, where 450 MHz is the operating frequency of the first and second delay lines 412 and 422. A power splitter 442, 444 is provided after each of the first and second frequency sources 432 and 434, respectively, before the first and second LO signals are provided to the respective image rejection mixers. In an example embodiment, the frequency sources 432 and 434 driving the image rejection mixers can be fine frequency tuned, leading to delay control resolution to the 10Ons level. For example, this can be achieved by provisioning a frequency synthesizer architecture to step the delay in any number of sweep patterns as required by the system, as would be known to one of ordinary skill in the art. Swept time varying delay will simulate a moving target return.

In an example embodiment, as shown in FIG. 18, the first tuning component 410 comprises a first hybrid coupler 454 and a first sideband selection switch 474 provided between the first image rejection mixer 414 and the first delay line 412. The first hybrid coupler 454 is configured to receive an output of the image rejection mixer 414 and to provide an output to the sideband selection switch 474. The first tuning component 410 further comprises a second hybrid coupler 456 and a second sideband selection 476 switch provided between the first delay line 412 and the second image rejection mixer 416. The sideband selection switch 476 is configured to receive an output of the first delay line 412 and to provide an output to the hybrid coupler 456. The third hybrid coupler 456 is configured to provide an output to the image rejection mixer 416.

Also as shown in FIG. 18, the second tuning component 420 comprises a third hybrid coupler 464 and a third sideband selection switch 484 provided between the third image rejection mixer 424 and the second delay line 422. The third hybrid coupler 464 is configured to receive an output of the image rejection mixer 424 and to provide an output to the sideband selection switch 484. The second tuning component 420 further comprises a fourth hybrid coupler 466 and a fourth sideband selection 486 switch provided between the second delay line 422 and the fourth image rejection mixer 426.

The sideband selection switch 486 is configured to receive an output of the second delay line 422 and to provide an output to the fourth hybrid coupler 466. The fourth hybrid coupler 466 is configured to provide an output to the image rejection mixer 426.

FIG. 18 also illustrates a microwave spurious suppression filter 490 configured to receive the output of the second tuning component 420 and to output a delayed RF output at 9.4 GHz. The microwave spurious suppression filter 490 at the output of the tunable delay is selected to suppress the LO signals from 432 and 434 and lower sideband components.

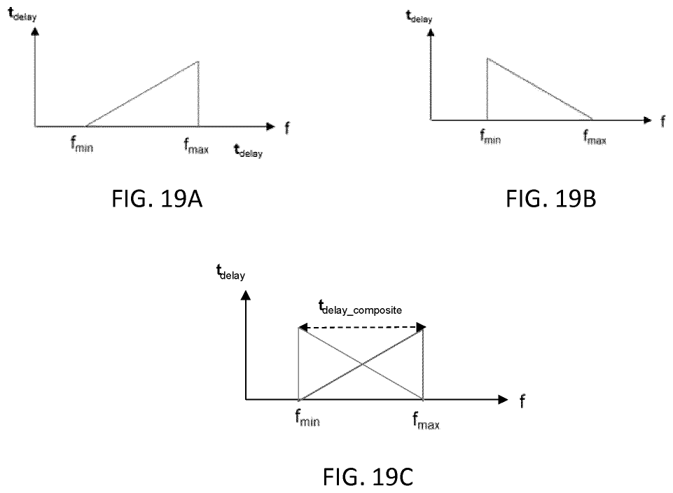

FIGS. 19A, 19B and 19C illustrate graphs of individual and composite delay of the delay device of FIG. 18. FIG. 19A illustrates a graph of delay versus frequency of the first tuning component 410 of FIG. 18, which includes dispersive delay line filter 412. FIG. 19B illustrates a graph of delay versus frequency of the second tuning component 420 of FIG. 18, which includes dispersive delay line filter 422, which is mirrored about LO. FIG. 19C illustrates a graph of the composite delay versus frequency of the delay device 400 of FIG. 18. Since the responses shown in FIG. 19A and FIG. 19B completely overlap between fₘᵢₙ and fₘₐₓ, this results in a maximum delay bandwidth, as shown in FIG. 19C.

The embodiments described thus far can be used for emulating delays associated with RADAR static and moving target tests. Embodiments of the present disclosure can be used to run a complete RADAR and test it in a laboratory with a variable target delay and see its performance. A combination of multiple parallel tunable delays can be used to emulate multiple target returns from different ranges. Application of frequency modulation to the LO signals enables synthesis of time varying delays which represent moving targets.

There are other scenarios in which phase noise is an aspect of interest. For instance, suppose there is a target traveling at a velocity that introduces a Doppler shift. Stationary ground clutter in the same range bin as the moving target is spread by the phase noise of the local oscillator into the target Doppler bin masking the target return. So, in this scenario, a RADAR system is unable to detect the target. The term “range bin” refers to a range of distances between a systems transmitting a signal, such as a RADAR system that the RADAR can resolve. There is a given delay value associated with each range bin. The term “Doppler bin” refers to a range of Doppler frequencies into which the frequency change caused by the target velocity is resolved. A stationary target, such as the ground, would ideally occupy the 0 Hz Doppler frequency bin, however, the phase noise of the local oscillator spreads the 0 Hz bin energy into higher frequency bins resulting in the target masking effect.

There are many scenarios of interest where an object is either already moving slowly, or the object is a small target moving relative to a large target and is difficult to distinguish. Suppose a super tanker is being observed, and someone drops an inflatable boat off of the side; it is then very difficult to see the inflatable boat in the presence of the significantly higher echo from the super tanker. In another example, if a person is walking across a roadway that is being observed, the road acts as ground clutter, masking the slow moving biological target (person). Additional embodiments of the present disclosure will now be described in relation to RADAR detection sensitivity.

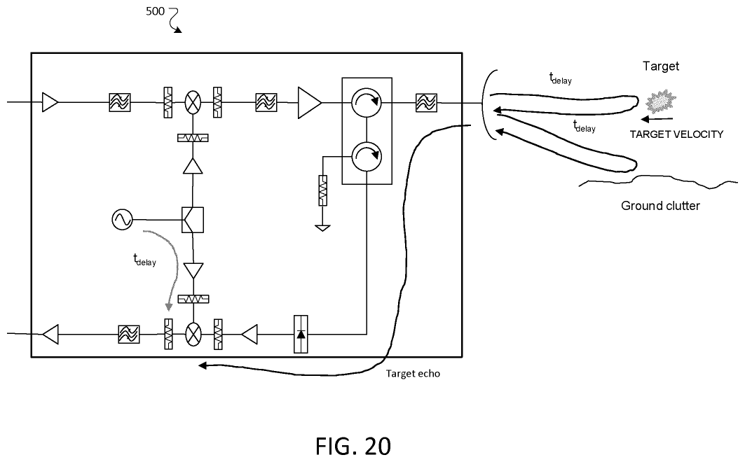

FIG. 20 illustrates a block diagram of a known pulse Doppler RADAR system showing target echo masking resulting from ground clutter. The RADAR system 500 as shown in FIG. 20 includes up and down frequency converters, a transmit power amplifier, a stable local oscillator (STALO), limiter, duplexer and low noise amplifier. In the case of the conventional RADAR system of FIG. 20, the RADAR STALO phase-noise-induced ground clutter will mask the target return, preventing detection.

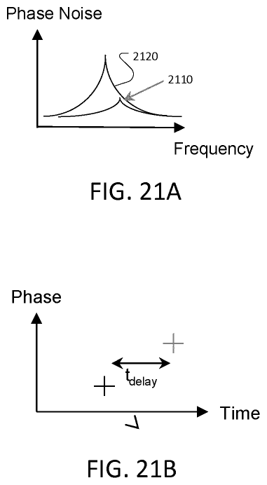

FIG. 21A illustrates a plot of phase noise versus frequency for the system of FIG. 20, showing the target echo 2110 masked by phase noise-induced clutter 2120. The observed target echo produces a delay that results in de-correlation of local oscillator phase noise, preventing clutter suppression at the down conversion mixer. FIG. 21B illustrates a plot of phase versus time for the system of the conventional RADAR configuration of FIG. 20 in which phase noise is not suppressed.

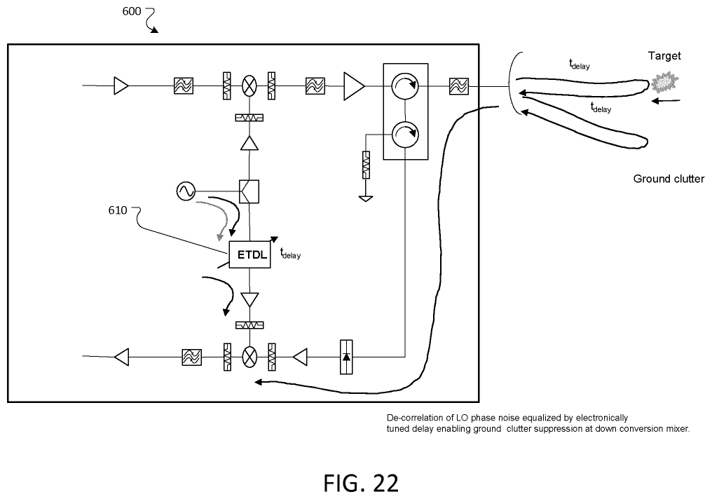

FIG. 22 illustrates a block diagram of a pulse Doppler RADAR system 600 including a delay device 610, for example an electronically tunable delay line, according to an embodiment of the present disclosure. In an example embodiment, the delay device 610 is implemented similar to one or more of: the delay device 100 of FIG. 1; the delay device 200 of FIG. 4; the delay device 300 of FIG. 10; or the delay device 400 of FIG. 18.

The delay device 610 in the RADAR system 600 is configured to cancel the local oscillator phase noise through equalization of the target return echo round trip delay with the down conversion LO signal. In the event that the delays are equalized, the RADAR STALO phase noise will be canceled from the signal return at the receiver down conversion mixer, enabling the target echo to be detected above the ground clutter. In an implementation, to determine the target return echo round trip delay, a target is hit with multiple pulses; the first pulse return would be used to determine the target range and set the delay of the delay device. In an implementation, the delay adjustment is performed automatically. As there could be targets of interest at different ranges, in an embodiment the enhanced sensitivity function is introduced for an operator selected target or range of interest.

The LO signal normally used in the RADAR performs up conversion of the transmitter IF and then down conversion of the received signal. In the time the transmit signal takes to get to the target and back to the RADAR, the LO phase noise has changed. In an embodiment, the delay device 610 delays the LO phase noise, enabling the noise of the LO to cancel the noise of the return echo in the down conversion mixer.

In an example embodiment, a range of interest is determined prior to operation, in relation to which the delay is set to remove ground clutter at that range. For example, a first range of interest is defined for detection of people crossing a border, where ground clutter becomes significant as the Doppler shift of the target is relatively low. In such a case, the delay would be set to reject RADAR oscillator induced clutter associated with the round trip delay relating to, or associated with, the ground segment of interest. A second example application is for detection of small vessels leaving a much larger vessel, in which case the clutter return from the larger vessel could mask the smaller target vessel. Finally, in a further example implementation, detection of low flying drones is enhanced using a RADAR system including a delay device 610, as such targets have small RADAR cross section and are typically masked by ground clutter if flown at low altitudes.

In an example implementation, employing the delay device 610 of FIG. 22, ground clutter problems are resolved over a particular distance range by equalizing the delay from the radar oscillator, applied to the up converter as applied to the down converter. In an embodiment, if this electronically tunable delay is made equal to the delay to the target within the particular distance range, then the noise cancels, and the target is visible, or can be distinguished from the ground clutter. Such an implementation provides improved target visibility in the presence of ground clutter, or sub-clutter visibility. In an example embodiment, the delay device 610, which can be an electronically controlled delay line, rejects the noise associated with the two transposition oscillators. While the noise introduced by the transposition oscillators is not of concern in RADAR test implementations, the embodiment of FIG. 22 uses the delay device 610 to reject the noise associated with the transposition oscillators. In an embodiment, de-correlation of LO phase noise is equalized by the delay device 610 enabling ground clutter suppression at the down conversion mixer.

In an example embodiment, the present disclosure provides a method of improving sensitivity of a communication signal transmission system, such as a RADAR system, comprising: obtaining a local oscillator signal; delaying the local oscillator signal by a time duration equal to a pulse round trip flight of interest between the system and a target within a distance range; and providing the delayed local oscillator signal to a receiver down converter mixer so as to cancel oscillator phase noise for a range of interest, resulting an improvement in the clutter to signal ratio of the system.

In an implementation, the local oscillator that drives the delay device has phase noise associated therewith; in an embodiment, this noise is equivalent to a clutter source and is suppressed to ensure the delay device does not increase the system noise and de-sensitize the system, for example a RADAR receiver.

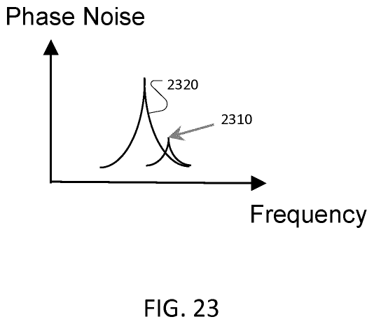

FIG. 23 illustrates a plot of phase noise versus frequency for the system of FIG. 22. In contrast to the plot in FIG. 21A in which the target echo is masked by phase noise induced clutter, the plot of FIG. 23 shows that the target echo 2310 is visible above the ground clutter 2320. This is enabled by the delay device 610 being configured to set a delay that rejects clutter associated with the round trip delay associated with the ground segment of interest, or distance range of interest.

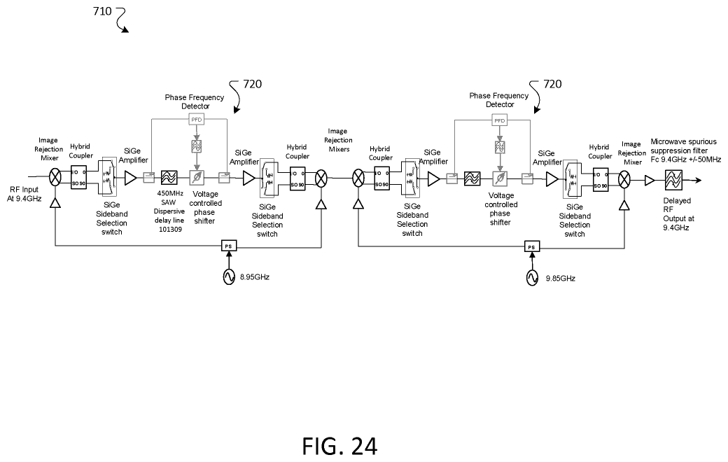

FIG. 24 illustrates a delay device 710, for example an electronically tunable delay line, according to another embodiment of the present disclosure. The delay device 710 comprises identical delay lines and image rejection mixer mirroring, similar to FIG. 18, and further comprises a phase noise suppression loop 720. The example embodiment of the delay device 710 in FIG. 24 is employed for clutter suppression and incorporates at least one phase noise suppression loop 720 which rejects the phase noise of the local oscillators present in the delay device structures. The phase noise suppression loops, or LO cancellation loops, 720 are shown in red and result in the delay device 710 being different from the RADAR test embodiments described earlier.

Though the embodiment of FIG. 24 includes a phase noise suppression loop 720, other embodiments are provided without the phase noise suppression loop. In such example implementations, the delay in the filters will result in the LO phase noise becoming de-correlated, which leads to the LO noise adding to the output system noise. In some example implementations, a low phase noise local oscillator is used such that the LO noise falls below that of the RADAR STALO noise, achieving a net improvement in clutter rejection.

The example embodiment of FIG. 24, similar to the embodiment of FIG. 28, has an RF input at 9.4 GHz, and a delayed RF output, which is also at 9.4 GHz. The first and second frequency sources are configured to generate first and second local oscillator signals at 8.95 GHz and 9.85 GHz, respectively. The first and second LO signals correspond to RFᵢₙ−450 MHz and to RFᵢₙ+450 MHz, where 450 MHz is the operating frequency of the first and second delay lines, shown as SAW dispersive delay lines.

Other details for the embodiment of FIG. 24 relating to the image rejection mixers, hybrid couplers, sideband selection switches, and frequency sources are similar to the details provided earlier in relation to FIG. 18.

In an embodiment, for example as described in relation to FIG. 22 to FIG. 24, the present disclosure provides an agile phase noise cancellation system. This is in contrast to known systems that are locked for use in canceling phase for a particular distance range. Though some known approaches provide limited discrete tunability by switching or stepping between different spools of optical fiber, embodiments of the present disclosure are not based on discrete delay. Because the target is moving, the delay is not necessarily known a priori. Even if the delay or distance is known a priori, known approaches provide only limited functionality, and do not provide the agile or active phase noise cancellation provided by embodiments of the present disclosure. For example, according to an embodiment of the present disclosure, a target can be detected and tracked based on active scanning, and the delay device adjusts the parameters based on needed delay adjustments in response to changing position and direction of the target.

Embodiments of the present disclosure provide the ability to suppress noise and enhance signal-to-clutter ratio over a spectrum of target ranges, not just a specific range. In an embodiment, the system is agile and is used to track an incoming target, increasing the RADAR sensitivity for a particular dynamic range profile.

Other embodiments of the present disclosure are provided for use in non-RADAR implementations. For example, adjustable delay can be used in phased array antennas for beam steering, and also for adaptive path equalization to avoid signal fading resulting from multi-path.

As outlined earlier, in addition to RADAR system test, the electronically tunable delay line of embodiments of the present disclosure provide a means to improve the RADAR sensitivity at a predetermined range through delay of the local oscillator signal fed to the receiver down converter mixer. By delaying the local oscillator signal by a time duration equal to the pulse round trip flight of interest, the oscillator phase noise is canceled for the range of interest resulting in an improvement in the clutter to signal ratio of the RADAR. Such capability is of particular advantage in situations in which the target is slow moving and at the same range as the stationary target, such as a person walking or alternatively a small vessel next to a much larger vessel.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A delay device comprising:
a tuning network configured to receive a reference signal at a reference frequency (f_{REF}) and configured to produce a radio frequency (RF) output signal in an RF band, the tuning network including:
a first tuning component including a first delay line, the first tuning component having a first frequency response, and
a second tuning component in communication with an output of the first tuning component such that the output of the first tuning component is provided as an input to the second tuning component, the second tuning component including a second delay line, the second tuning component having a second frequency response;
the first and second frequency responses of the first and second tuning components overlapping in an intermediate frequency (IF) band to provide a group delay response for the tuning network; and
a delay modifier in communication with the tuning network and configured to provide an offset frequency as an input to the tuning network and to electronically adjust a group delay value associated with the group delay response by varying the offset frequency, the delay modifier configured to provide a local oscillator frequency,
the difference between the reference frequency (f_{REF}) and the local oscillator frequency being substantially equal to an intermediate frequency of the tuning network, and
the tuning network and the delay modifier cooperating to transpose the reference signal at the reference frequency down to the IF band before passing through the first and second delay lines, and back up to the RF band after passing through the first and second delay lines.

2. The delay device of claim 1, wherein the delay modifier is configured to electronically adjust the center frequency of the group delay response to adjust the group delay value.

3. The delay device of claim 1, wherein, the reference signal and the RF output signal are both in a RADAR frequency band and the delay device is for use in a RADAR system.

4. The delay device of claim 3, wherein, the reference signal and the RF output signal are both in a frequency range of about 8.0 GHz to about 12.0 GHz.

5. The delay device of claim 3, wherein the tuning network and the delay modifier cooperate to transpose the reference signal at the reference frequency down to the intermediate frequency band before passing through the first and second delay lines, and back up to the RADAR frequency band after passing through the first and second delay lines.

6. The delay device of claim 3, wherein a delay characteristic of the group delay response is substantially flat over a bandwidth equal to or greater than an operating bandwidth of the RADAR system such that a RADAR signal is delayed equally at all frequencies within its bandwidth.

7. The delay device of claim 1, wherein the tuning network and the delay modifier cooperate to transpose the reference signal at the reference frequency down to the intermediate frequency band before passing through the first and second delay lines, and back up to an RF frequency band after passing through the first and second delay lines.

8. The delay device of claim 1, wherein the delay modifier comprises first and second frequency sources providing first and second local oscillator (LO) frequencies, respectively, and the offset frequency is based on a difference between the first and second local oscillator frequencies.

9. The delay device of claim 8 wherein the delay modifier is configured to electronically adjust the group delay value by adjusting the first local oscillator frequency or the second local oscillator frequency.

10. The delay device of claim 8 wherein:
the first tuning component further comprises:
a first frequency mixer configured to receive the reference signal and the first tuning frequency as inputs and configured to provide a first mixer output as an input to the first delay line; and
a second frequency mixer configured to receive the output of the first delay line and the first tuning frequency as inputs and configured to provide a second mixer output as the output of the first tuning component; and
the second tuning component further comprises:
a third frequency mixer configured to receive the output of the first tuning component and the second tuning frequency as inputs and configured to provide a third mixer output as an input to the second delay line; and
a fourth frequency mixer configured to receive the output of the second delay line and the second tuning frequency as inputs and configured to provide the RF output signal as the output of the fourth frequency mixer.

11. The delay device of claim 10, wherein the first frequency mixer, the second frequency mixer, the third frequency mixer and the fourth frequency mixer each comprise an image rejection mixer configured to remove a sideband signal from the output RF signal.

12. The delay device of claim 10, wherein:
the first frequency mixer, the second frequency mixer, the third frequency mixer and the fourth frequency mixer each comprise a double balance mixer configured to remove a sideband from the output RF signal, and
the delay device further comprising:
a filter at the output of each of the first frequency mixer, the second frequency mixer, the third frequency mixer and the fourth frequency mixer to remove a sideband signal from the output RF signal.

13. The delay device of claim 1, wherein the delay modifier comprises:
a first microwave synthesizer in communication with the first delay line and providing a first frequency as an input to the first delay line;
a second microwave synthesizer in communication with the second delay line and providing a second frequency as an input to the second delay line;
the delay modifier being configured to electronically adjust the group delay value by adjusting a difference between the first frequency and the second frequency such that the RF signal is converted to a passband of the IF processing component.

14. The delay device of claim 13 wherein the first microwave synthesizer provides the first frequency in an IF band and the second microwave synthesizer provides the second frequency in the IF band.

15. The delay device of claim 14 wherein the first and second frequencies provided by the first and second microwave synthesizers are between about 10 MHz and about 3 GHz.

16. The delay device of claim 14 wherein the first and second frequencies provided by the first and second microwave synthesizers are between about 10 kHz and about 3 GHz.

17. The delay device of claim 13, wherein the first and second microwave synthesizers are implemented using direct digital synthesis technology or fractional-N synthesis technology such that the frequency offset is adjustable at a sub-hertz level, which enables fine electronic control of the group delay.

18. The delay device of claim 13, wherein the first microwave synthesizer provides a first local oscillator frequency, and the second microwave synthesizer provides a second local oscillator frequency.

19. The delay line of claim 1, wherein the first and second delay lines each comprise frequency dispersive filters having a delay which is a function of the IF signal frequency equal to the difference between the input frequency value and the LO frequency value.

20. The delay device of claim 1, wherein the first and second delay lines each comprise dispersive surface acoustic wave (SAW) filters.

21. The delay device of claim 1, wherein the first delay line and the second delay line comprise substantially identical dispersive surface acoustic wave (SAW) filters.

22. The delay device of claim 8, wherein:
the first delay line and the second delay line comprise substantially identical dispersive surface acoustic wave (SAW) filters having a dispersion slope, and
the tuning network further comprises a plurality of image rejection mixers in communication with the delay modifier and in communication with the first and second delay lines, the plurality of image rejection mixers configured to mirror the second delay line about the first tuning frequency to invert the dispersion slope of the second delay line.

23. The delay device of claim 22, wherein the plurality of image rejection mixers comprises first, second, third and fourth image rejection mixers,
the first tuning component comprising the first delay line coupled between the first and second image rejection mixers;
the second tuning component comprising the second delay line coupled between the third and fourth image rejection mixers.

24. The delay device of claim 22, further comprising:
a first power splitter provided after the first frequency source and before the first LO signal is provided to the first and second image rejection mixers; and
a second power splitter provided after the second frequency source and before the second LO signal is provided to the third and fourth image rejection mixers.

25. The delay device of claim 23, further comprising a plurality of hybrid couplers and a plurality of sideband selection switches, the plurality of hybrid couplers cooperating with the plurality of sideband selection switches to enable selection of a lower or upper sideband to enable mirroring of the dispersion gradient and to generate quadrature signals at the image rejection mixer IF port.

26. The delay device of claim 23, further comprising a plurality of hybrid couplers and a plurality of sideband selection switches,
the first tuning component comprising one of the hybrid couplers and one of the sideband selection switches at each end of the first delay line;
the second tuning component comprising one of the hybrid couplers and one of the sideband selection switches at each end of the second delay line.

27. The delay device of claim 23, wherein
the first tuning component comprises a first hybrid coupler and a first sideband selection switch provided between the first image rejection mixer and the first delay line, and a second hybrid coupler and a second sideband selection switch provided between the first delay line and the second image rejection mixer;
the second tuning component comprises a third hybrid coupler and a third sideband selection switch provided between the third image rejection mixer and the second delay line, and a fourth hybrid coupler and a fourth sideband selection switch provided between the second delay line and the fourth image rejection mixer.

28. The delay device of claim 22, further comprising:
a microwave spurious suppression filter configured to receive the output of the second tuning component and to output a delayed RF output, the microwave spurious suppression filter being selected to suppress the first and second LO signals and lower sideband components.

29. The delay device of claim 1, wherein:
the first frequency response of the first tuning component has a positive delay-versus-frequency slope; and
the second frequency response of the second tuning component has a negative delay-versus-frequency slope.

30. The delay device of claim 8, wherein the first delay line and the second delay line are substantially identical dispersive surface acoustic wave (SAW) filters each having a center frequency of f_{CF}, and the delay modifier produces the first and second LO frequencies based on f_{REF}−f_{CF} and f_{REF}+f_{CF}.

31. The delay device of claim 30 wherein the first tuning frequency is substantially equal to f_{REF}−f_{CF} and the second tuning frequency is substantially equal to f_{REF}+f_{CF}.

32. The delay device of claim 1, wherein the first and second frequency responses of the first and second delay lines overlap in the intermediate frequency band to provide a substantially flat group delay response in a passband of a composite filter for the tuning network.

33. The delay device of claim 1, wherein, when the offset frequency is adjusted by 1 MHz, the group delay response increases by about 4.5 microseconds while maintaining a substantially flat group delay response.

34. The delay device of claim 1, wherein the group delay response is a function of the offset frequency and is independent of the reference frequency of the reference signal.

35. The delay device of claim 1, wherein the group delay response is based on
D1+D2=((dt/df))*Δf+t0+t1, where
D1=(−dt/df)*f+t0, and is a first delay based on the dispersion gradient of the first SAW filter
D2=(dt/df)*(f+Δf)+t1, and is a second delay based on the inverted dispersion gradient of the second SAW filter
and where D1+D2 is a function of the offset frequency and is independent of the reference frequency of the reference signal.

36. The delay device of claim 3, wherein the RADAR frequency band comprises an X-band frequency range.

37. The delay device of claim 3, wherein the delay line has an operational bandwidth equivalent to the operational bandwidth of the first and second tuning components.

38. The delay device of claim 37, wherein the operational bandwidth of the first and second tuning components is from about 100 MHz to about 40 GHz.

39. The delay device of claim 1, wherein the intermediate frequency band is defined by a range of about 10 MHz to about 3 GHz.

40. The delay device of claim 5 wherein the tuning network and the delay modifier cooperate to transpose the reference signal at the reference frequency down to the intermediate frequency band before passing through the first and second delay lines, such that a ratio of the reference signal at the reference frequency to the transposed reference signal in the intermediate frequency band is about 1000:1.

41. The delay device of claim 40 wherein the ratio of the reference signal at the reference frequency to the transposed reference signal in the intermediate frequency band is about 100:1.

42. A delay device comprising:
a tuning network configured to receive a reference signal at a reference frequency (f_{REF}) and configured to produce a radio frequency (RF) output signal in an RF band, the tuning network including:
a first tuning component including a first delay line, the first tuning component having a first frequency response, and
a second tuning component including a second delay line, the second tuning component having a second frequency response;
the first and second frequency responses of the first and second tuning components overlapping in an intermediate frequency (IF) band to provide a group delay response for the tuning network; and
a delay modifier in communication with the tuning network and configured to provide an offset frequency as an input to the tuning network and to electronically adjust a group delay value associated with the group delay response by varying the offset frequency, the delay modifier configured to provide a local oscillator frequency,
the difference between the reference frequency (f_{REF}) and the local oscillator frequency being substantially equal to an intermediate frequency of the tuning network, and
the tuning network and the delay modifier cooperating to transpose the reference signal at the reference frequency down to the IF band before passing through the first and second delay lines, and back up to the RF band after passing through the first and second delay lines.

43. The delay device of claim 42 wherein the second tuning component is configured in parallel with the first tuning component so as to emulate multiple RADAR target returns occurring at different distances from the RADAR system.

44. The delay device of claim 38 wherein the first and second tuning components are provided in a plurality of parallel tuning components, each tuning component comprising an electronically tunable delay line, configured to provide a plurality of parallel delay paths configured to emulate a plurality of target returns.

45. A method of emulating radar signal propagation delays between a RADAR and a target in a RADAR system under test, comprising:
receiving, at a tuning network including first and second tuning components having first and second delay lines, respectively, a reference signal at a reference frequency (f_{REF}) in a RADAR frequency band;
transposing, at the tuning network, the reference signal at the reference frequency down to an intermediate frequency band before passing through the first and second delay lines, and back up to the RADAR frequency band after passing through the first and second delay lines, an output of the first tuning component being provided as an input to the second tuning component, the first and second tuning components having first and second frequency responses, respectively, which overlap in the intermediate frequency band to provide a group delay response for the tuning network;
providing an offset frequency as an additional input to the tuning network;
electronically adjusting a group delay value associated with the group delay response by varying the offset frequency; and
producing a radio frequency (RF) output signal, the RF output signal being in the RADAR frequency band.

46. The method of claim 45 wherein:
receiving the reference signal at the reference frequency in an X-band frequency range;
transposing the reference signal at the reference frequency down to the intermediate frequency band and back up to the X-band frequency range; and
producing the RF output signal in the X-band frequency range.

47. A method of improving sensitivity of a communication signal transmission system configured to detect a target, comprising:
obtaining a local oscillator signal;
delaying the local oscillator signal by a time duration equal to a pulse round trip flight of interest between the system and the target within a distance range; and
providing the delayed local oscillator signal to a receiver down converter mixer so as to cancel oscillator phase noise for a range of interest, resulting in an improvement in the clutter to signal ratio of the system.

48. The method of claim 47 wherein the communication signal transmission system comprises a Radio Detection And Ranging (RADAR) system.
